(19) United States
(12) Patent Application Publication
(10) Pub. No.: US 2018/0319007 A1
(43) Pub. Date: Nov. 8, 2018

(54) Automated Mechanic Creeper

(71) Applicant: Travis Wilkinson, Thomaston, AL (US)

(72) Inventor: Travis Wilkinson, Thomaston, AL (US)

(21) Appl. No.: 15/587,134

(22) Filed: May 4, 2017

(51) Int. Cl. B25H 5/00; B66F 11/04

(52) U.S. Cl. CPC B25H 5/00; B66F 11/04

(57) ABSTRACT

An automated mechanics creeper employing a base frame, a mast and a support platform whereby a mechanic can mount the support platform and by actuating an electrical wheel motor system and a hydraulic system can position a mechanic above an engine compartment in a comfortable and ideal position for purposes of making a repair to an automobile. The hydraulic system comprises a lift hydraulic cylinder which raises or lowers a support platform, a transverse hydraulic cylinder attached to said mast and attached to a vertical support frame which moves the support platform left to right, an extension cylinder joined to a pivot platform having parallel tracks and said extension cylinder further joined to the support platform having parallel rails whereby said parallel rails travel in said parallel tracks such that the extension cylinder can position the mechanic forwards and backwards, and a tilt hydraulic cylinder which tilts the support platform by connection of the vertical support frame with a crossbar of the pivot platform. The hydraulic system is controlled by a hydraulic control module and the electric wheel motor system is controlled via a wheel control module both of which said control modules are adjacent and in reach to a mechanic on the support platform.

### CROSS-REFERENCE TO RELATED APPLICATIONS

None

### FEDERALLY SPONSORED RESEARCH

None

### SEQUENCE LISTING

None

### FIELD OF THE INVENTION

The invention relates to a mechanic creeper for use by a mechanic over the engine compartment of a vehicle and more specifically relates to an automated creeper such that a mechanic can adjust their position over an engine compartment by using simple hand controls.

### BACKGROUND OF THE INVENTION

Auto and heavy equipment mechanics work on a variety of vehicles or machines that have different dimensions and have engine compartments that are located at heights and depths that are hard to reach by a mechanic. Specifically, mechanics often times have to make repairs to vehicles on engine compartments that are much higher than they can reach and extend back towards a vehicle rendering it impossible for a mechanic to position themselves to make repairs without having to climb upon the vehicle and contort their bodies to maintain a comfortable position on top of an open engine compartment where they are forced to lay upon various odd shaped and sized engine components that can cause discomfort or difficulty in maintaining an ideal vantage to perform a repair. Often, mechanics are required to step up onto the front bumper of a vehicle and bend over the engine compartment to reach the subject repair site which can cause back strain or injury to a mechanic. Years of this repeated activity can cause a mechanic to lose their ability to repair vehicles due to physical injury.

While mechanic creepers exist in the art they are all limited in their attempts to give a mechanic unlimited automated position adjustment. Further, none of the creepers that exist in the art allow a mechanic to adjust their position in any direction while they are laying on the creeper support. What is need in the art is an automated mechanic creeper that will lift a mechanic to a desired vantage over an engine compartment, position the mechanic on a support platform at a desired position horizontally or angularly, extend the mechanic over an engine compartment a desired depth and position them laterally across the engine compartment. Further, what is needed in the art is a mechanic creeper that requires minimum human effort to position a mechanic in a desired location.

### SUMMARY OF THE INVENTION

Specific advantages and features of the present invention will be apparent from the accompanying drawings and the specification of the present invention.

The present invention is a mechanic creeper comprised of a base frame, two front wheels in communication with wheel motors, a rear caster wheel attached to the rear point of the base frame, and a mast joined to the base frame on its front whereby the mast is formed of an inner post and a mast upper sleeve. The mast inner post is connected to the mast upper sleeve by inserting a lift hydraulic cylinder into the inner post with the barrel end of the hydraulic cylinder installed into the bottom of the inner post and the piston rod of the hydraulic cylinder threaded on its end and inserted into an aperture on the mast upper sleeve surface and a nut to secure the piston rod in position. Joined to the mast upper sleeve is a transverse support rail having a rail edge on its upper and bottom surface. The transverse support rail is adapted to receive a diagonal support that has an upper track wheel and a lower track wheel such that the track wheels ride the support rail and maintain position by way of the track wheels having double flanges on their outer perimeter. The diagonal support is joined to a vertical support frame that is comprised of vertical parallel arms having terminal ends that have apertures through said terminal ends and a crossbar that connects the vertical parallel arms and said crossbar having an aperture through the vertical parallel arms and crossbar.

There is also joined to the mast upper sleeve front surface a transverse hydraulic cylinder on its barrel and which is parallel to the transverse support rail. The piston rod of the transverse hydraulic cylinder is installed through the aperture in the cross bar of the vertical support frame and secured on the furthest side of the vertical support frame parallel arm. The transverse hydraulic cylinder works in concert with the transverse support rail whereby the transverse hydraulic cylinder provides the force and the transverse support rail provides support to move a creeper support platform from side to side.

The mechanic creeper also comprises a pivot platform having parallel tracks, a crossbar connecting the parallel tracks, bosses formed onto the interior edge of the parallel tracks, apertures through said bosses, and a junction block having an aperture whereby the pivot platform is connected to the vertical support frame by the alignment of the boss apertures, the apertures located in the terminal ends of the parallel arms of the vertical support frame and the junction block aperture whereby a connection pin is inserted through said apertures of the boss apertures, terminal end apertures and junction block aperture. Joined to the junction block on its upper surface is an extension hydraulic cylinder whereby the barrel of the extension hydraulic cylinder is joined to the junction block. The creeper further comprises a tilt hydraulic cylinder mounted to the transverse support rail at its barrel end and the piston rod of said tilt hydraulic cylinder connected to the crossbar of the pivot platform.

The creeper further comprises a support platform mounted to a support platform frame whereby the frame is joined to two parallel rails with joint plates and whereby the parallel rails are inserted into said parallel tracks of the pivot platform and the piston rod of the extension hydraulic cylinder is connected to a crossbar located on the support platform frame. The support platform is made up of a lower rigid planar support with a padded surface on top of the planar support.

The support platform by way of attachment to the pivot platform and the junction of the vertical frame parallel arms with the pivot platform creates a pivot point and allows the support platform to be tilted to a desired angle. The tilt function allows a mechanic to place their body on the support platform and the tilt hydraulic cylinder when actuated will bring the mechanic to a desired angular or horizontal position. This allows a mechanic to mount the creeper without the assistance of a ladder or other similar device and the mechanic can then be raised to an appropriate height from the ground.

The creeper is powered by an electrical system which drives the wheel motors and also drives a hydraulic system that actuates the lift hydraulic cylinder, the transverse hydraulic cylinder, the extension hydraulic cylinder and the tilt hydraulic cylinder. The creeper position is controlled by use of a wheel control module that is hand operated and the support platform is controlled by a hydraulic control module that is hand operated all while a mechanic is resting on the support platform.

### DESCRIPTION OF THE DRAWINGS

The invention is generally depicted in FIGS. 1-12 but may be embodied in various other forms. The principles and teachings of the invention, therefore, can be applied to numerous alternative variations.

FIG. 1 is a perspective view of the mechanic creeper.

FIG. 2 is a partial exploded perspective view of the mechanic creeper.

FIG. 3 is an exploded view of the mechanic creeper.

FIG. 4 is a side elevation of the mechanic creeper.

FIG. 5 is a front plan view of the mechanic creeper.

FIG. 6 is a top plan view of the mechanic creeper.

FIG. 7 is a perspective view of the pivot frame assembled to the vertical support frame.

FIG. 8 is an exploded view of the pivot frame and vertical support frame assembly.

FIG. 9 is a side elevation of the vertical support frame.

FIG. 10 is a top plan view of the mechanic creeper frame.

FIG. 11 is a blended schematic of the electrical system and the hydraulic system.

FIG. 12 is a perspective view of a mechanic mounted on the creeper suspended over an automobile engine compartment.

### DETAILED DESCRIPTION

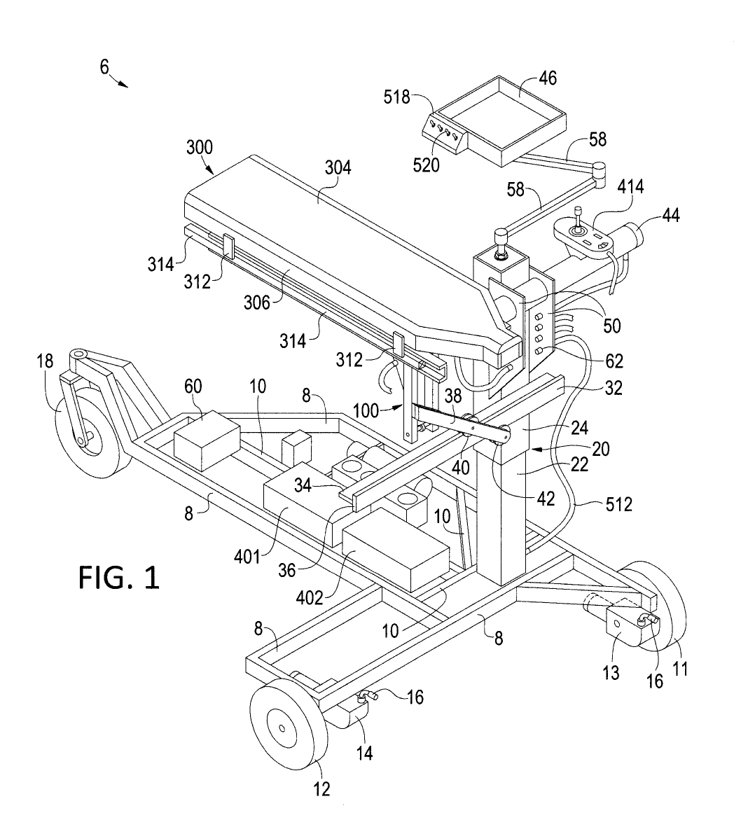

Referring now to FIGS. 1-3 there is shown a mechanic creeper 6 having a base frame 8 having an outer perimeter and cross members 10 located interior to said base frame 8 outer perimeter. The base frame 8 is connected to a left wheel motor 13 on its front left which in turn is connected to a left wheel 11 and to a right wheel motor 14 on its front right which in turn is connected to a right wheel 12. The left wheel motor 13 and right wheel motor 14 have a wheel lock 16 which prevents the creeper 6 from moving from a chosen position once the wheel locks 16 are engaged. The base frame 8 also terminates into a rear elevated portion of the base frame 8 that is connected to a rear caster wheel 18. The rear caster wheel 18 is not powered and is present for purposes of stability and support of the creeper 6 along with passive mobility in positioning the creeper 6. The base frame 8 on its front left portion extends forward a distance from the mast such that the left wheel 11 is located a distance forward of the mast 20 and the front right wheel 12. This extended portion of the base frame 8 gives the creeper 6 additional stability and allows the left wheel 11 to be positioned underneath a car or on the outside of a car tire. If the right wheel 12 were extended like the left wheel 11, the creeper 6 would encounter the tire of a vehicle and not be able to get any closer to the vehicle engine compartment. Having only the left wheel 11 extended forward allows for adequate stability and maneuverability of the creeper 6. In one embodiment, the base frame 6 and left wheel 11 is extended 18 inches in front of the mast 20.

There is a mast 20 comprised of a mast inner post 22 and a mast upper sleeve 24 and a lift hydraulic cylinder 26 disposed within the mast inner post 22 and master upper sleeve 24 such that it connects the master inner post 22 and mast upper sleeve 24. The mast inner post 22 is joined to the base frame 8 cross members 10 by either welding or fasteners such as nuts and bolts. In one embodiment, the mast inner post 22 and mast upper sleeve 24 dimensions are rectangular in cross-section and in a range of between 5.5-6.5 inches by 5.5 inches-6.5 inches and taking into account an appropriate tolerance between the mast inner post 22 and mast upper sleeve 24 such that the mast upper sleeve 24 can slide over the mast inner post 22 without obstruction but with minimum play between the mast upper sleeve 24 and mast inner post 22. Located within the mast inner post 22 and mast upper sleeve 24 is the lift hydraulic cylinder 26 whereby the barrel 30 is connected to the bottom of the mast inner post 22 and the piston rod 28 is connected to the top surface of the mast upper sleeve 24. This is achieved by having threaded ends on the both the piston rod 28 and the barrel 30 of the lift hydraulic cylinder 26 whereby the threaded ends are inserted into apertures on the top of the mast upper sleeve 24 and the bottom of the mast inner post 22 and secured with a washer and nut. The lift hydraulic cylinder 26 piston rod 28 travels upward by hydraulic pressure and travels downward by gravitational force.

Attached to the mast upper sleeve 24 is a transverse support rail 32 joined to the mast upper sleeve 24 whereby the transverse support rail 32 is a horizontal T shape whereby there is a horizontal component 34 joined to a vertical perpendicular component 36. In one embodiment, the transverse support rail 32 could be cast or molded as one piece or it could be formed by joining a horizontal component 34 to a vertical perpendicular component 36 to form the transverse support rail 32. The vertical perpendicular component 36 is dimensioned and purposed to act as a rail on its upper surface and on its lower surface such as to accommodate and fit an upper track wheel 40 and a lower track wheel 42. There are vertical supports plate 50 welded to the mast upper sleeve 24 on its left and right side having apertures for installation of a transverse hydraulic cylinder 44 that is joined to both the mast upper sleeve 24 and vertical support plates 50 by welding. The transverse hydraulic cylinder 44 is transverse to the mast upper sleeve 24. Further, the vertical support plates 50 act as a junction for the hydraulic hoses 512 whereby they can be mounted at a central location apertures formed in the vertical support plates 50.

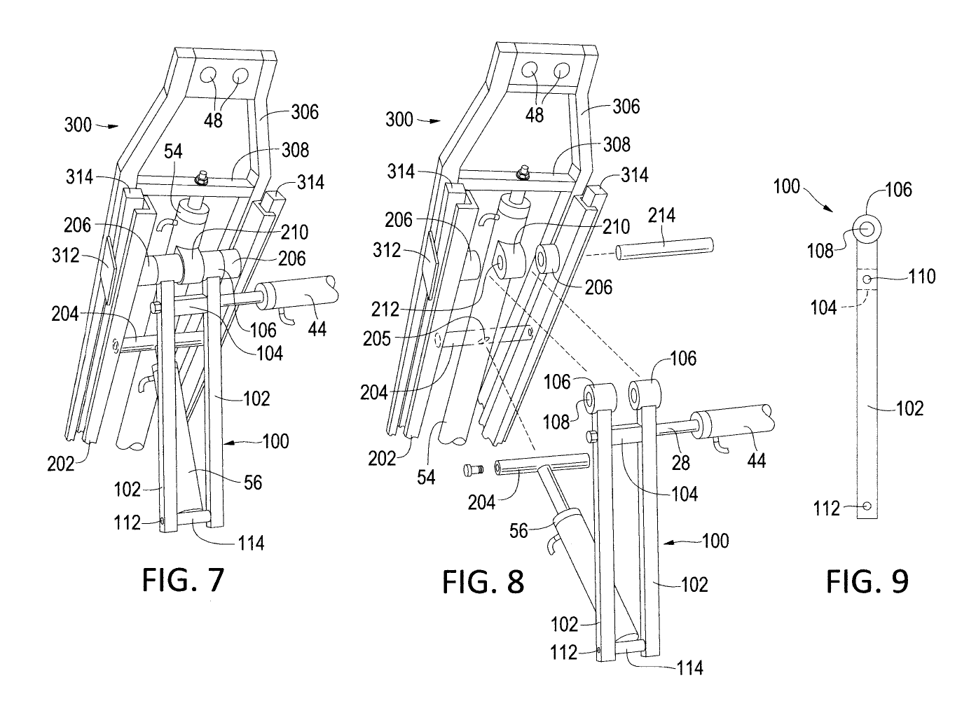

There is further shown a diagonal support 38 having an upper track wheel 40 and a lower track wheel 42 located on its length whereby said track wheels 40 and 42 are positioned on to the transverse support rail 32 such that the upper track wheel 40 is in communication with the upper surface of the transverse support rail 32 and the lower track wheel 42 is in communication with the bottom surface of the transverse support rail 32. The upper track wheel 40 and lower track wheel 42 are double flanged along their annular perimeters such that they do not become disengaged from the transverse support rail 32. The diagonal support 38 and the transverse hydraulic cylinder 44 are joined to a vertical support frame 100 as shown in FIGS. 1-3 and the vertical support frame 100 is in more detail shown in FIGS. 7-9 where the vertical support frame 100 is comprised of vertical parallel arms 102 having terminal ends 106 that have apertures 108 through said terminal ends 106 and a crossbar 104 that connects the vertical parallel arms 102 and said crossbar 104 having an aperture 110 as shown in FIG. 9 formed through its interior and the vertical parallel arms 102 at the same location. The transverse hydraulic cylinder 44 barrel 30 as discussed above is mounted to the mast upper sleeve 24 and the piston rod 28 of the transverse hydraulic cylinder 44 is mounted through said aperture 110 of the crossbar 104 and vertical support frame 100 parallel arms 102 and secured to the vertical support frame 100 by means of the piston rod 28 being threaded on its end and using appropriate fasteners such as nuts and washers to make the connection.

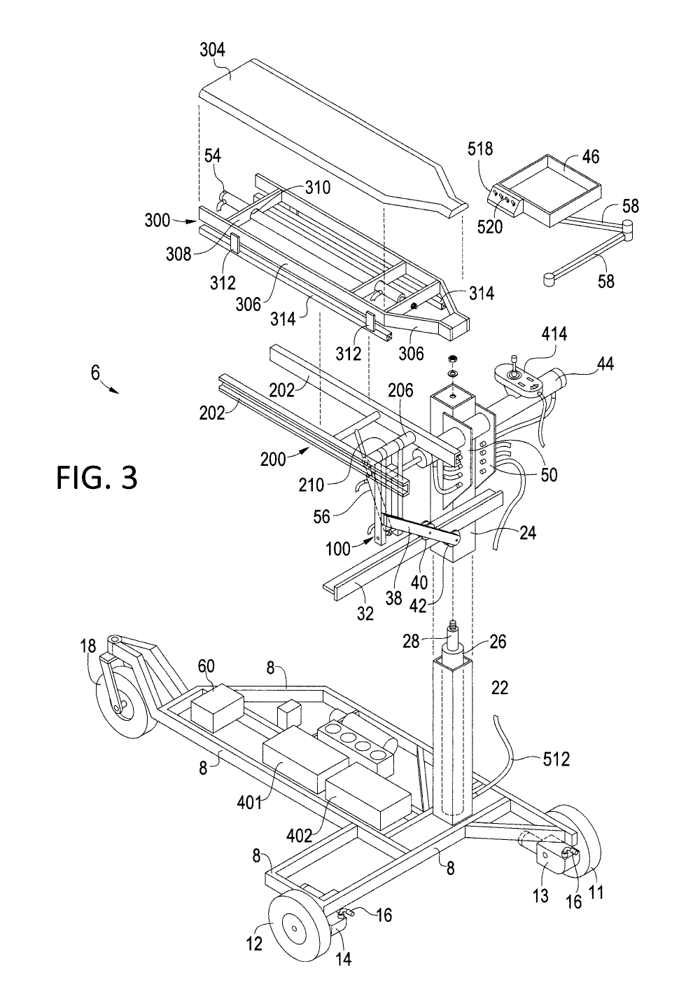

Further shown in FIGS. 7 and 8 is a pivot platform 200 having parallel tracks 202, a crossbar 204 connecting the parallel tracks 202, bosses 206 formed onto the interior edge of the parallel tracks 202, apertures 208 through said bosses 206, and a junction block 210 having an aperture 212 whereby the pivot platform 200 is connected to the vertical support frame 100 by the alignment of the boss 206 apertures 208, the apertures 108 located in the terminal ends 106 of the parallel arms 102 of the vertical support frame 100, and the junction block 210 aperture 212 whereby a connection pin 214 is inserted through said boss 206 apertures 208, terminal end 106 apertures 108 and junction block 210 aperture 212. There is an extension hydraulic cylinder 54 joined to said junction block 210 on its barrel 30. There is also shown a tilt hydraulic cylinder 56 whereby the tilt hydraulic cylinder barrel 30 is joined to the bottom of the vertical support frame 100 and the piston rod 28 of the tilt hydraulic cylinder 56 is connected to the crossbar 204 of the pivot platform 200 as shown in FIGS. 3, 4, 5, 7 and 8.

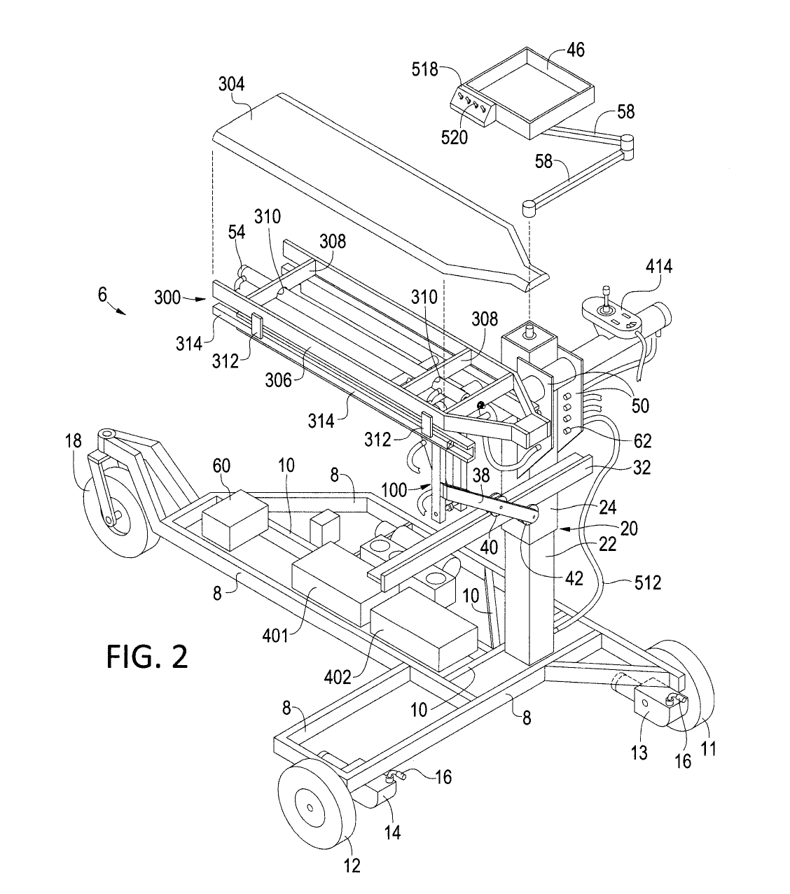

FIGS. 1-3 show a support platform 300 made up of a planar support 302 which has a pad 304 on its top side and a support platform frame 306. The planar support 302 can be wood, metal or plastic or other rigid material that will attach to the support platform frame 306. The support platform frame 306 is shown having an outer perimeter frame portion with cross members 308. The cross members 308 have cutouts 310 as shown in FIG. 2 for installation of the extension hydraulic cylinder 54 on the support platform frame 306 such that the extension hydraulic cylinder is recessed inside the support platform frame 306 and out of the way for installation of the support platform 300 onto the pivot platform 200. Located along the outside of the support platform frame 306 are joint plates 312 which join the support platform frame 306 to parallel rails 314 that are installed and configured to slide in the parallel tracks 202 of the pivot platform 200. The joint plates 312 are welded to the support platform frame 306 and the parallel rails 314. The support platform 300 is connected to the pivot platform 200 by inserting the parallel rails 314 into the parallel tracks 202 of the pivot platform 200. Once this installation takes place, the extension hydraulic cylinder 54 that is connected to the junction block 210 can be installed onto the support platform 300 by way of taking the extension hydraulic cylinder 54 piston rod 28 that has been threaded on its end and joining the extension hydraulic cylinder 54 to a cross member 308 located at the front of the support platform frame 306 that has an aperture to receive said piston rod 28 and fastening it thereto with washers and nuts. Once the extension hydraulic cylinder 54 is mounted to the support platform frame 306, the mechanic creeper is operational, and the lift hydraulic cylinder 26, the transverse hydraulic cylinder 44, the extension hydraulic cylinder 54 and the tilt hydraulic cylinder 56 work in concert with each other and the left and right wheel motors 13 and 14 to position a mechanic in a desirable position over a vehicle engine compartment. In one embodiment, aluminum can be used to form the base frame 8, mast inner post 22, mast upper sleeve 24, transverse support rail 32, diagonal support 38, vertical support frame 100, pivot platform 200, support platform frame 306 as well as the hydraulic cylinders. However, other materials and/or metals such as steel could be used.

Looking further at FIGS. 1-3 there is shown a tool tray 46 attached to the mast upper sleeve 24 top surface by means of a pivot arm 58. The pivot arm 58 is threaded and attached on to the threaded end of the piston rod 28 of the lift hydraulic cylinder 26. The pivot arm 58 allows a mechanic to place tools, parts and other items in the tool tray 46 and to position the tool tray to a desired working position. Located on the tool tray is a hydraulic control module 518 that controls the lift hydraulic cylinder 26, the transverse hydraulic cylinder 44, the extension hydraulic cylinder 54 and the tilt hydraulic cylinder 56 by using momentary toggle switches 520 that allow a hydraulic cylinder to be extended or retracted. Further shown is a ballast weight 60 located at the rear of the creeper 6 base frame 8. The ballast weight 60 is used to keep the creeper 6 stable and from tipping forwards while a mechanic is perched upon the support platform 300. The ballast weight 60 in one embodiment can weigh anywhere from 15 pounds to 50 pounds but any weight that achieves the stabilizing purpose can be used. Also shown in FIGS. 1-3 is a wheel control module 414 having a directional joystick control 416, a speed selector 418, battery charge indicator 420 and a charge port 422.

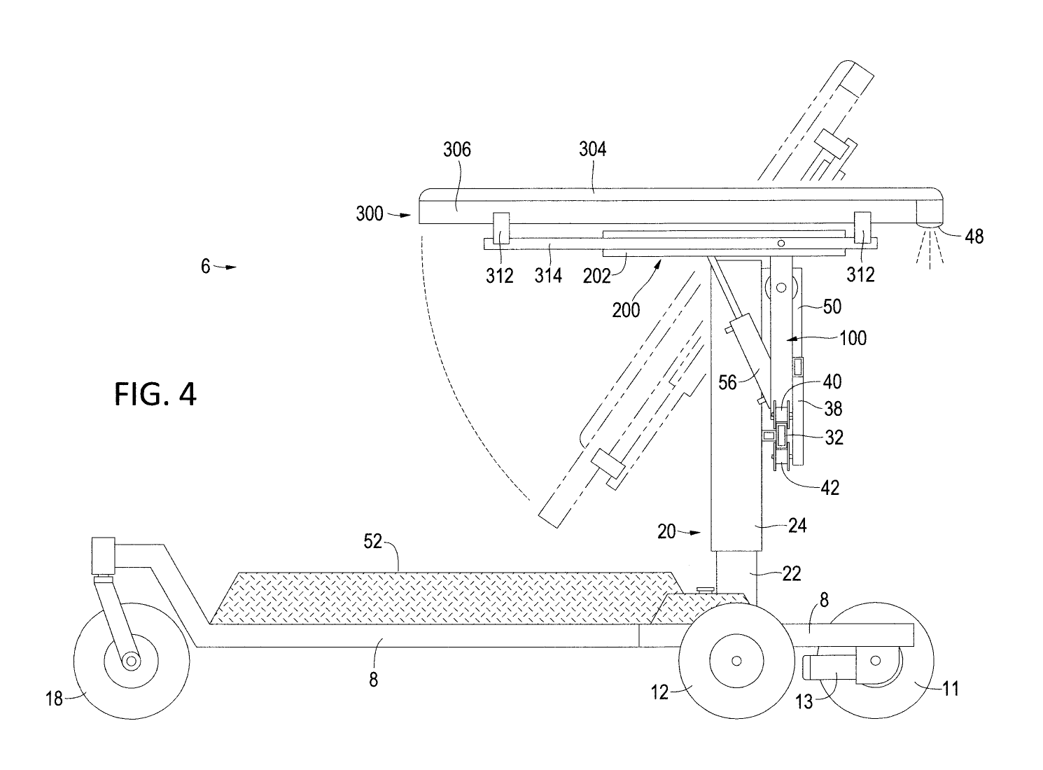

FIG. 4 is a side profile view of the creeper 6 showing the support platform 300 and its range of motion by actuating the tilt hydraulic cylinder 56. The tilt hydraulic cylinder 56 enables a mechanic to mount the support platform 300 by tilting it at an angle that allows the mechanic to mount the support platform in a safe and effective fashion and by further allowing the mechanic to have a desired angled position above a vehicle engine compartment if so desired. Also shown is the hydraulic fluid reservoir 502 mounted on the base frame 8 adjacent to the right wheel 13. A cover 52 is shown that shelters the hydraulic and electrical system components. In addition, there is a light 48 mounted on the front underside of the support platform frame 306 that points in the direction of a vehicle engine compartment when the support platform 300 is positioned over a vehicle engine compartment. Also shown is the left wheel 11 and left wheel motor 13 extended a distance in front of the mast 20 and the right wheel 12.

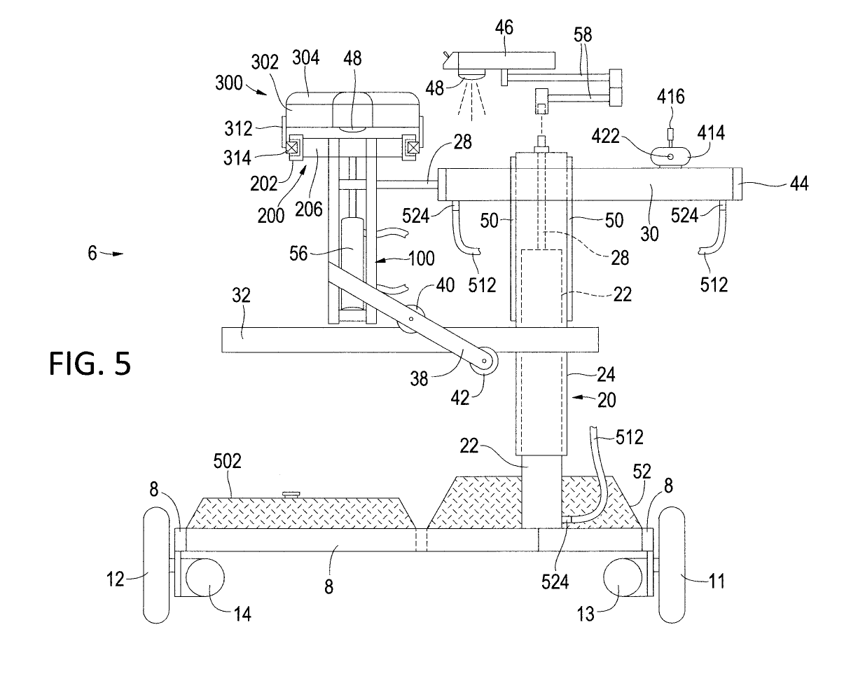

Referring now to FIG. 5, there is shown a front elevation of the creeper 6 where the diagonal support 38 and upper track wheel 40 and lower track wheel 42 is installed onto the transverse support rail 32. The transverse hydraulic cylinder 44 is attached to the vertical support frame 100 and when actuated it moves the diagonal support 38 along the transverse support rail 32 via the upper track wheel 40 and lower track wheel 42 which the diagonal support 38 in turn is attached to the vertical support frame 100 which in turn is connected to the pivot platform 200 which in turn is connected to the support platform 300. The transverse hydraulic cylinder 44 causes the support platform 300 to move in a side to side fashion by actuating the hydraulic control module 518 switch 520 in a desired direction. Also shown by broken lines is the mast inner post 22 and the lift hydraulic cylinder 26 piston rod 28 which when said lift hydraulic cylinder 26 is actuated it lifts the entire creeper 6 support assembly up to a desired position that is high enough to position above a vehicle engine compartment. Also shown is a light 48 on the underside of the tool tray 46 as well as a light 48 on the underside of the support platform 300.

Hydraulic lines 512 leading to the various hydraulic cylinders are shown. The transverse hydraulic cylinder 44, the extension hydraulic cylinder 54 and the tilt hydraulic cylinder 56 are two directional hydraulic cylinders such that they extend and retract in opposing directions. The lift hydraulic cylinder 26 is one dimensional in the upward vertical direction and is controlled by gravity in the downward vertical direction once the hydraulic pressure is release on the cylinder using the appropriate hydraulic control module 518 switch 520. The hydraulic cylinders can be operated simultaneously via the hydraulic control module 518. In one embodiment, the travel length of the lift hydraulic cylinder 26 piston rod 28 is 30 inches, the extension hydraulic cylinder 54 piston rod 28 is 28 inches, the transverse hydraulic cylinder 44 piston rod 28 is 28 inches, and the tilt hydraulic cylinder 56 piston rod 28 is between 9 and 10 inches of travel length, however, various hydraulic cylinder lengths can be utilized.

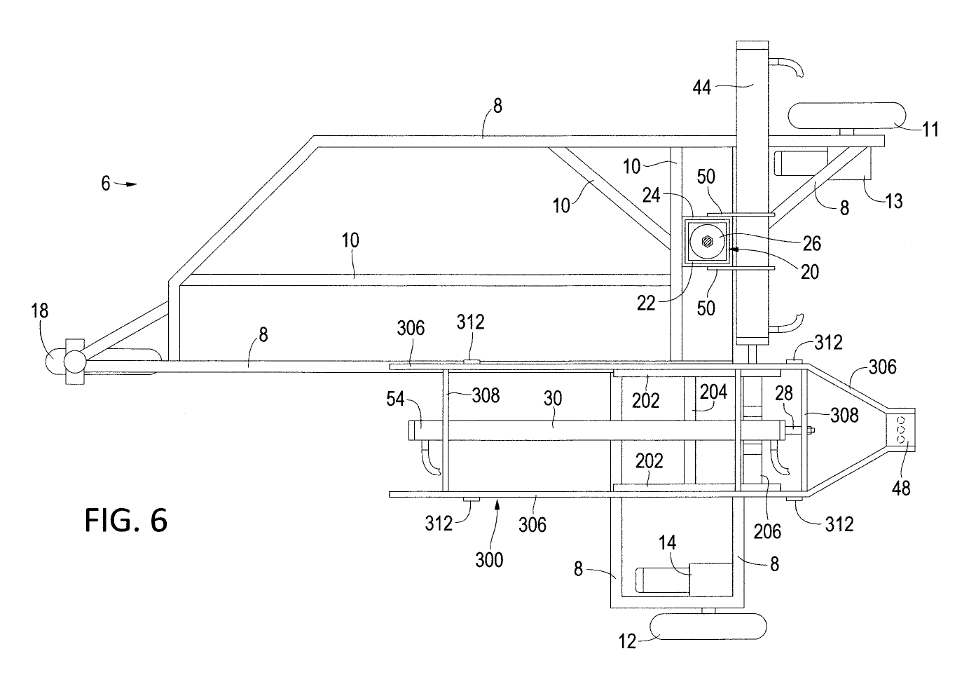

Referring now to FIG. 6, there is shown a top plan elevation of the creeper 6 showing the base frame 8 structure and cross members 10 and the support platform frame 306 structure. The extension hydraulic cylinder 54 is shown mounted to the support platform frame 306 crossbar 308. The mast 20 is shown in a section view such that the mast inner post 22, mast upper sleeve 24 and lift hydraulic cylinder 26 and piston rod 28 are shown. Wheel motors 12 and 14 are shown with wheels 11 and 13 along with rear caster wheel 18.

FIGS. 7 is a bottom angled perspective view that shows the connection of the vertical support frame 100 with the pivot platform 200 via the bosses 206 formed on the interior side of the parallel tracks 202 of the pivot platform 200 and the terminal ends 106 of the vertical support frame 100 and the junction block 210 mounted to the extension hydraulic cylinder 54 by insertion of a connection pin 214, the connection of the tilt hydraulic cylinder 56 connecting the vertical support frame 100 with the pivot platform 200 cross bar 204, and the transverse hydraulic cylinder 44 connection to the vertical support frame 100.

FIG. 8 is an exploded bottom perspective view of FIG. 7 where it shows how the connection pin 214 joins the pivot platform 200 to the vertical support frame 100 by insertion of the connection pin 214 through the boss 206 apertures 208, through the terminal end 106 apertures 108 of the vertical support frame 100 and through the junction block 210 that is joined to the extension hydraulic cylinder 54. Also shown is the tilt hydraulic cylinder 56 that is attached to the bottom of the vertical support frame 100 via apertures 112 in the vertical support frame 100 and a crossbar 114 that is inserted into the apertures 112. A hole is drilled in the crossbar 114 such that it will receive a threaded end of the barrel 30 of the tilt hydraulic cylinder 56. The piston rod 28 of the tilt hydraulic cylinder 56 is threaded on its end and is linked to the crossbar 204 of the pivot platform by way of an aperture 205 through the crossbar 204 and washer and nut connection. Shown also are hydraulic lines 512 on the tilt hydraulic cylinder 56 and the transverse hydraulic cylinder 44. When the tilt hydraulic cylinder 56 piston rod 28 is fully extended, the angle of the support platform 300 is slightly below horizontal level such that the front portion of the support platform 300 where a mechanic's head will in the general vicinity be located will be slightly lower than the back portion of the support platform 300 where a mechanic's feet will be located. When the tilt hydraulic cylinder 56 piston rod 28 is fully retracted, the support platform 300 angle will have an angle of around 45 degrees with horizontal level but the angle could be more or less than 45 degrees. When the support platform 300 via the tilt hydraulic cylinder 56 is in a fully retracted or somewhat retracted position, it is easiest for a mechanic to mount the creeper 6 support platform 300. From this position, the mechanic can than begin to move the creeper 6 and support platform 300 via controls to achieve a desired position over a vehicle engine compartment. Further shown in FIGS. 7-8 is at least one light 48 located on the front underside of the support platform frame 306 such that it is positioned to project light downwards into a vehicle engine compartment.

FIG. 9 is a side elevation of the vertical support frame 100 having terminal end 106 aperture 108, aperture 110 for connection to the transverse hydraulic cylinder 44 and aperture 112 for connection to the tilt hydraulic cylinder 56.

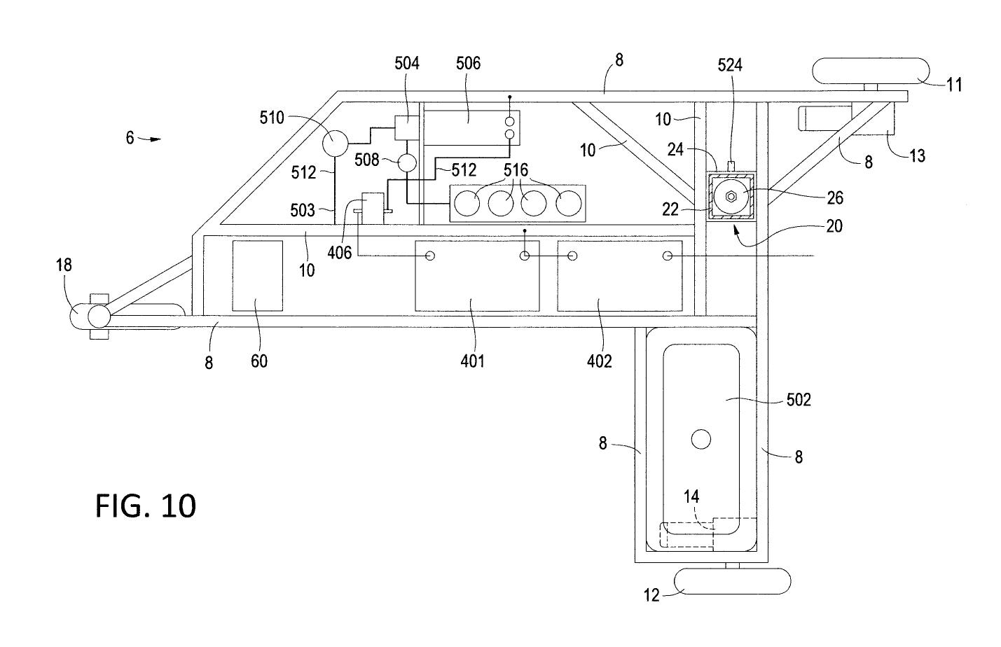

Referring now to FIG. 10 there is shown a top plan view of the creeper 6 base frame 8 showing the location of the electrical and hydraulic system components. There is a first battery 401 and second battery 402. There is also shown a hydraulic pump motor 506, a hydraulic pump 504, hydraulic filter 510, a hydraulic regulator 508, hydraulic hoses 512, four hydraulic spool valves 516 and a magnetic relay 406. These components are attached to the base frame 8 by various mounting brackets common in the art. Also shown is the hydraulic reservoir 502, the left wheel 11 and right wheel 13, and the lift hydraulic cylinder 26 contained in the mast 20 which is comprised of the mast inner post 22 and the mast upper sleeve 24. Also shown is the hydraulic inlet-outlet port 524 for the lift hydraulic cylinder 26.

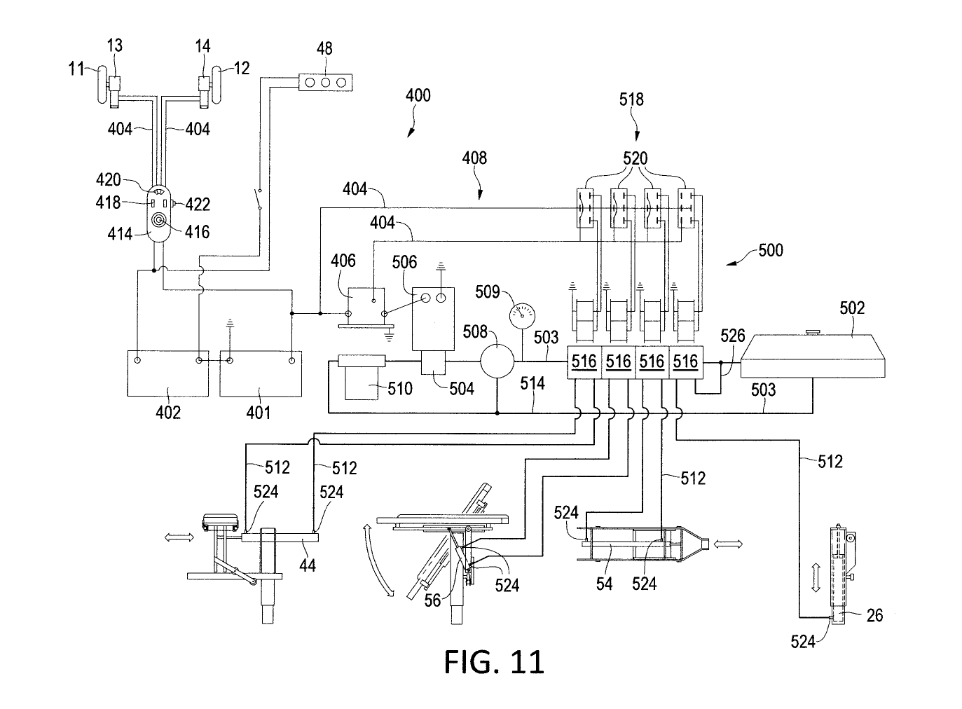

Referring now to FIG. 11 there is shown a schematic of the electrical system 400 and the hydraulic system 500. Beginning with the electrical system 400, there is shown a first battery 401 and a second battery 402. Both batteries 401 and 402 are 12 volt direct current batteries and are linked in series. In the present embodiment, direct current power is advantageous compared to alternating current as an electrical power source due to the mobility of the creeper 6 and the problems associated with plugging the creeper 6 up to an electrical cord that may become disengaged during operation, tangled with the creeper or damaged leading to the potential of electrical shock. However, an alternating current power system is feasible and is in one embodiment envisioned for the present invention. In addition rechargeable batteries 401 and 402 can be lead acid batteries, nickel metal hydride batteries, or lithium ion batteries. Shown are the left wheel 11 and wheel motor 13 and the right wheel 12 and wheel motor 14 connected via electrical wire 404 to the wheel control module 414 and to batteries 401 and 402. The wheel motors 12 and 14 circuit is powered by both 401 and 402 batteries in series such that the wheel motors 12 and 14 run off 24 volt power. The wheel control module 414 has a direction control 416, speed selector 418, and battery charge indicator 420, and a charging port 422 that can be connected to an extension cord and charged via an alternating current power source. Located within the wheel control module 414 is a charging circuit that converts the alternating current power to direct current power and recharges batteries 401 and 402. Also shown in the electrical system 400 is a light 48 that is powered only by the second battery 402. Further, while only one light 48 is shown, there can be more than one light in a series or parallel circuit with the light 48.

The hydraulic system 500 is run by the second battery 402 whereby the second battery positive terminal is connected to the hydraulic motor 506 and pump 504, magnetic relay 406 and hydraulic control module 518 momentary toggle switches 520 and four bi-directional hydraulic spool valves 516 that control the hydraulic cylinders mentioned herein. The negative terminal of the second battery 402 is grounded 522 to the base frame 8. Using the base frame 8 as the ground allows the completion of the circuit without a return wire. The magnetic relay 406 is connection with the momentary toggle switches 520 of the hydraulic control module 518 such that when a momentary toggle switch 520 is actuated in one of two directions, the magnetic relay 406 acts a slave to handle the high current for the momentary toggle switch 520. The hydraulic system 500 stores hydraulic fluid in a hydraulic reservoir 502 that is fed in a clockwise manner as shown in FIG. 11 via a hydraulic feed line 503 and first flows to a hydraulic fluid filter 510, then to the hydraulic pump 504 which pressurizes the fluid to around 2,000 pounds per square inch. The hydraulic fluid then flows to a regulator 508 which steps the hydraulic pressure down to around 700 pounds per square inch due to using aluminum hydraulic cylinders on the creeper 6. There is a pressure gauge 509 connected to the hydraulic feed line 503 downstream of the regulator that allows the mechanic to adjust the regulator 508 to an appropriate pressure. The hydraulic feed line 503 then delivers the hydraulic fluid to the hydraulic spool valves 516 and has a return and/or recycle feed line 503 back to the hydraulic reservoir 502. More than one hydraulic cylinder can be operated at one time.

Further shown in FIG. 11 is the connection of the transverse hydraulic cylinder 44, the tilt hydraulic cylinder 56, the extension hydraulic cylinder 54 and the lift hydraulic cylinder 26 connected by hydraulic hoses 512 to their respective spool valve 516. The transverse hydraulic cylinder 44, the tilt hydraulic cylinder 56, the extension hydraulic cylinder 54 have bidirectional hydraulic capabilities whereas the lift hydraulic cylinder 26 has a one way hydraulic capability in the upward vertical component direction and a downward gravity controlled vertical direction. Shown also are directional arrows showing the directional movement that is achieved when each hydraulic cylinder is actuated. Further shown is a recycle line 526 coming from the spool valve 516 for the lift hydraulic cylinder 26 when gravity forces the lift hydraulic cylinder 26 in a downward position it allows for the recycling of hydraulic fluid back to the reservoir 502.

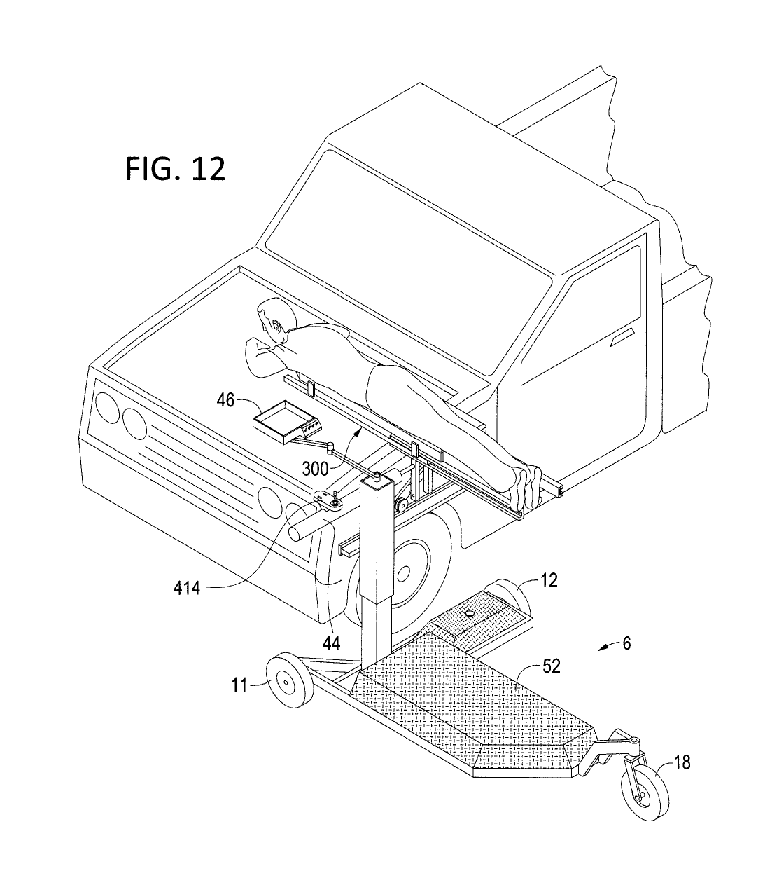

Referring now to FIG. 12, there is shown the creeper 6 having a mechanic mounted about a vehicle engine compartment on the support platform 300. Shown is the wheel control module 414 and the hydraulic control module 518 such that in the displayed embodiment requires a user to operate the wheel control module 414 and hydraulic control module 518 with their left hand. As a protective feature of the invention, the wheel control module is mounted on the transverse hydraulic cylinder 44 at a distance from the support platform 300 such that when the support platform is extended to the right by the transverse hydraulic cylinder 44 a certain distance, the wheel control module 414 becomes unreachable to the mechanic so that they cannot move the creeper 6 via the wheel 11 motor 13 and wheel 12 motor 14 because of potential stability issues while attempting to reposition the creeper 6 with the transverse hydraulic cylinder 44 extended out a certain length. The present embodiment can also be presented in a mirror image such that it can accommodate an individual based on their preference. The mirror image of the creeper 6 would have the support platform 300 on the left side of the mast when looking down at a top plan view of the creeper 6.

The principles, embodiments, and modes of operation of the present invention have been set forth in the foregoing specification. The embodiments disclosed herein should be interpreted as illustrating the present invention and not as restricting it. The foregoing disclosure is not intended to limit the range of equivalent structure available to a person of ordinary skill in the art in any way, but rather to expand the range of equivalent structures in ways not previously contemplated. Numerous variations and changes can be made to the foregoing illustrative embodiments without departing from the scope and spirit of the present invention.

What is claimed is:

1. A mechanic creeper, comprising:
A base frame;
A front left wheel and a front right wheel connected to the base frame;
at least one rear caster wheel connected to the rear of said base frame;
a wheel motor in communication with the front left wheel and a wheel motor in communication with the front right wheel;
a mast joined to the base frame wherein the mast is comprised of a mast inner post joined to the base frame and a mast inner sleeve that encapsulates said inner post;
a lift hydraulic cylinder mounted in the bottom of the mast inner post onto the base frame and a piston of said lift hydraulic cylinder connected to the top of the mast upper sleeve;
a transverse support rail joined to the mast upper sleeve;
a diagonal support having an upper track wheel and a lower track wheel located on its length whereby said track wheels are positioned on to the transverse support rail such that the upper track wheel is in communication with the upper surface of the transverse support rail and the lower track wheel is in communication with the bottom surface of the transverse support rail;
a vertical support frame joined to the diagonal support where the vertical support frame is comprised of vertical parallel arms having terminal ends that have apertures through said terminal ends and a crossbar that connects the vertical parallel arms and said crossbar having an aperture through the vertical parallel arms and crossbar;
a transverse hydraulic cylinder mounted to the mast upper sleeve whereby a piston rod of the transverse hydraulic cylinder is mounted through said aperture of the crossbar of the vertical support frame and secured to the vertical support frame;
a pivot platform having parallel tracks, a crossbar connecting the parallel tracks, bosses formed onto the interior edge of the parallel tracks, apertures through said bosses, and a junction block having an aperture whereby the pivot platform is connected to the vertical support frame by the alignment of the boss apertures, the apertures located in the terminal ends of the parallel arms of the vertical support frame and the junction block aperture whereby a connection pin is inserted through said boss apertures, terminal end apertures and junction block aperture;
an extension hydraulic cylinder joined to said junction block on its barrel;
a tilt hydraulic cylinder connected to the vertical support frame at its barrel end, and the piston rod of said tilt hydraulic cylinder connected to the crossbar of the pivot platform;
a support platform mounted to a support platform frame whereby the frame is joined to two parallel rails with joint plates and whereby the parallel rails are inserted into said parallel tracks of the pivot platform and the piston rod of the extension hydraulic cylinder is connected to a crossbar located on the support platform frame;
an electrical system for operation of said wheel motors and a hydraulic system;
the hydraulic system connected to and powering said lift hydraulic cylinder, said transverse hydraulic cylinder, said extension hydraulic cylinder and said tilt hydraulic cylinder;
a wheel control module; and
a hydraulic control module.

2. The mechanic creeper of claim 1 wherein the base frame on its front left portion extends forward a distance from the mast such that the front left wheel is located a distance forward of the mast.

3. The mechanic creeper of claim 1 further comprising a tool tray attached to a pivoting arm whereby said pivoting arm is joined to the top of the mast upper sleeve.

4. The mechanic creeper of claim 3 wherein the hydraulic control module is located on the tool tray.

5. The mechanic creeper of claim 1, further comprising at least one vertical support plate adjoined to the side of the mast having an aperture through it for installation of the transverse hydraulic cylinder and apertures for the installation of hydraulic lines.

6. The mechanic creeper of claim 1 further comprising a light connected to the electrical power system for illumination of a work area.

7. The mechanic creeper of claim 1 wherein the wheel control module has an electrical charging port for recharging the electrical system.

8. The mechanic creeper of claim 1 further comprising a removable cover installed over the electrical system and hydraulic system.

9. The mechanic creeper of claim 1 wherein the wheel control module is mounted on the transverse cylinder.

10. The mechanic creeper of claim 1 further comprising a ballast weight located on the rear of the base frame.

11. The mechanic creeper of claim 1 further comprising a light located on the tool tray and a light located on the support platform frame.

12. A mechanics creeper, comprising;
a base frame;
a front left wheel and a front right wheel connected to the base frame;
at least one rear caster wheel connected to the rear of said base frame;
a wheel motor in communication with the front left wheel and a wheel motor in communication with the front right wheel;
a hydraulic positioning system joined to said base frame further comprising four hydraulic cylinders joined to a positioning frame that allows a mechanic to rest upon a support platform and position themselves in a vertical up or down direction, in a horizontal left and right position, in a horizontal forward and back position, and in a tilt position such that the support platform pivots in an angular position relative to a horizontal position;
an electrical system for operation of said wheel motors and a hydraulic system;
the hydraulic system connected to and powering said four hydraulic cylinders;
a wheel control module; and
a hydraulic control module.

13. The mechanic creeper of claim 12 wherein the base frame on its front left portion extends forward a distance from the mast such that the front left wheel is located a distance forward of the mast.

14. The mechanic creeper of claim 12 further comprising a tool tray attached to a pivoting arm whereby said pivoting arm is joined to the top of the mast upper sleeve and a hydraulic control module is located on the tool tray.

15. The mechanic creeper of claim 12 further comprising at least one vertical support plate adjoined to the side of the mast having an aperture through it for installation of the transverse hydraulic cylinder and having apertures for the installation of hydraulic lines.

16. The mechanic creeper of claim 12 further comprising at least one light connected to the electrical system for illumination of a work area.

17. The mechanic creeper of claim 12 wherein the wheel control module has an electrical charging port for recharging the electrical system and said wheel control module is mounted on the transverse hydraulic cylinder.

18. The mechanic creeper of claim 12 further comprising a removable cover installed over the power system and hydraulic system.

19. The mechanic creeper of claim 12 further comprising a ballast weight located on the rear of the base frame.

20. The mechanic creeper of claim 12 further comprising a light located on the tool tray and a light located on the support platform frame.
